(19) United States
(12) Patent Application Publication
(10) Pub. No.: US 2009/0310794 A1
(43) Pub. Date: Dec. 17, 2009

(54) AUDIO CONFERENCE APPARATUS AND AUDIO CONFERENCE SYSTEM

(75) Inventors: Toshiaki Ishibashi, Fukuroi-shi (JP); Ryo Tanaka, Hamamatsu-shi (JP); Satoshi Ukai, Hamamatsu-shi (JP)

Correspondence Address: ROSSI, KIMMS & McDOWELL LLP., 20609 Gordon Park Square, Suite 150, Ashburn, VA, 20147, US

(73) Assignee: YAMAHA CORPORATION, Hamamatsu-shi, Shizuoka (JP)

(21) Appl. No.: 12/441,698

(22) PCT Filed: Dec. 17, 2007
(86) PCT No.: PCT/JP2007/074254

§ 371 Date: Mar. 17, 2009

(30) Foreign Application Priority Data
Dec. 19, 2006 (JP) 2006-341176

(51) Int. Cl. H04B 3/20

(52) U.S. Cl. 381/66

(57) ABSTRACT

To provide an audio conference apparatus and an audio conference system which can smoothly proceed with the audio conference by removing a recursion sound of the conference voice is achieved. An audio conference apparatus 1 outputs ring tones from corresponding channels before a communication control unit 12 outputs audio signals from the unused channels (S1 to S3). Speakers SP1 to SP16 emits the ring tone from predetermined sound source positions corresponding to the respective channels. Microphones MIC1A to MIC16A and microphones MIC1B to MIC16B collect audio signals including a recursion sound of the ring tone. The echo cancel unit 20 generates a pseudo-recursion sound signal on the basis of an input signal, and subtracts the pseudo-recursion sound signal from the collected audio signals. An audio conference system is configured to connect a plurality of the audio conference apparatuses to each other.

### TECHNICAL FIELD

The present invention relates to an audio conference apparatus and an audio conference system which can carry out an audio conference between multiple spots connected to one another through a network.

### BACKGROUND ART

When the audio conference is carried out between remote locations, a method of transmitting and receiving audio signals is widely used in which the audio conference apparatus is provided at every spot carrying out the audio conference and these apparatuses are connected to one another through a network. Further, various kinds of the audio conference apparatuses using the audio conference described above are disclosed (refer to Patent Document 1).

In the conventional audio conference apparatus, a voice emitted from a speaker is reflected on walls/doors or directly returns to a microphone. Therefore, the voice is affected by a transmission system (echo pass) and then is collected in the microphone as a recursion sound. Since the recursion sound cause a trouble in a call, in the conventional audio conference apparatus, an adaptive filter (adaptive digital filter) is used for carrying out a recursion sound removal process by removing the recursion sound from the audio signals collected in the microphone.

In the conventional recursion sound removal process, a convolution process is carried out on the audio signal emitted from the speaker using the adaptive filter which simulates the echo pass to generate a pseudo-recursion sound signal. Therefore, the recursion sound is removed by subtracting the pseudo-recursion sound signal from the audio signals collected in the microphone. At this time, a filter factor of the adaptive filter is updated such that the subtraction (error signal) between the pseudo-recursion sound signal simulating the recursion sound and the recursion sound is minimized. The updated filter factor is made to converge to a suitable value, so that the subtraction between the recursion sound and the pseudo-recursion sound signal is minimized. Therefore, it is possible to remove the recursion sound from the audio signals collected in the microphone.
Patent Document 1: JP-A-8-298696

### DISCLOSURE OF THE INVENTION

### Problem that the Invention is to Solve

However, at the time of starting the audio conference, the filter factor is not proper, and the recursion sound is not matched with the pseudo-recursion sound signal, in general. Therefore, it is impossible to remove the recursion sound from the audio signals collected in the microphone. In addition, in order for converging the filter factor, it takes some period of time (convergence period of time) for the process, and the recursion sound cannot be effectively removed during these periods of time.

An object of the present invention is to provide an audio conference system which can smoothly proceed with the audio conference from the beginning of the audio conference, and an audio conference apparatus used in the audio conference system.

### Means for Solving the Problems

According to an aspect of the present invention, there is provided an audio conference apparatus comprising:

a communication control unit which transmits and receives an audio signal to and from an opponent apparatus connected;

a sound emitting unit which emits an audio signal received in the communication control unit;

a sound collecting unit which collects an audio signal around one's own apparatus including a recursion sound of the audio signal emitted from the sound emitting unit; and

an echo cancel unit which generates a pseudo-recursion sound signal on the basis of the audio signal received in the communication control unit and outputs an audio signal obtained by subtracting the pseudo-recursion sound signal from the audio signal collected at the sound collecting unit to the communication control unit,

wherein the sound emitting unit emits an audio signal made of a ring tone before emitting the audio signal received in the opponent apparatus; and

wherein the echo cancel unit optimizes the pseudo-recursion signal in advance by using the audio signal of the ring tone.

According to such a configuration, the filter factor is made to converge on the basis of the ring tone emitted from the sound emitting unit. Therefore, after emitting the ring tone, the adaptive filter converges, and elimination of the recursion sound is suitably carried out. In addition, by emitting the ring tone, a notice of connection between one's own apparatus and an opponent apparatus is given to participants in the audio conference using one's own apparatus. Therefore, it is possible to suppress that a conference voice spoken after emitting the ring tone becomes the recursion sound to prevent the call, and it can make the audio conference smoothly proceed.

In addition, according to the aspect of the present invention, the sound emitting unit emits the audio signals, which are received from a plurality of opponent apparatuses, from sound source positions different from one another, and emits a ring tone with respect to a new sound source position before emitting the audio signal received from any one of the plurality of opponent apparatuses from the new sound source position.

According to such a configuration, the sound source position is differently set for every opponent apparatus so as to carry out a sound source process for emitting an input voice signal. Therefore, it is possible to make the scene alive of the audio conference to be higher.

In this case, the proper filter factor of the adaptive filter is differently set for every sound source position. Here, the ring tone is emitted before an audio signal of the conference voice is emitted from a new sound source position. As a result, the filter factor of the adaptive filter can converge before the emission of the conference voice.

Further, according to another aspect of the present invention, there is provided an audio conference apparatus comprising:

a communication control unit which transmits and receives an audio signal to and from an opponent apparatus connected;

a sound emitting unit which emits an audio signal received in the communication control unit;

a sound collecting unit which collects an audio signal around one's own apparatus including a recursion sound of the audio signal emitted from the sound emitting unit; and

an echo cancel unit which generates a pseudo-recursion sound signal on the basis of the audio signal received in the communication control unit and outputs an audio signal obtained by subtracting the pseudo-recursion sound signal from the audio signal collected at the sound collecting unit to the communication control unit,

wherein the communication control unit transmits an audio signal of a dial tone to the opponent apparatus before transmitting the audio signal received from the echo cancel unit to the opponent apparatus; and

wherein the echo cancel unit optimizes the pseudo-recursion signal in advance by an audio signal on the basis of the dial tone transmitted from the opponent apparatus.

According to such a configuration, the filter factor is made to converge on the basis of the dial tone emitted from the sound emitting unit. Therefore, after emitting the dial tone, the adaptive filter converges, and elimination of the recursion sound is suitably carried out. In addition, by emitting the dial tone, a notice of connection between one's own apparatus and the opponent apparatus is given to participants in the audio conference using one's own apparatus. Therefore, it is possible to suppress that the conference voice spoken after emitting the dial tone becomes the recursion sound to prevent the call, and it can make the audio conference smoothly proceed.

In addition, according to the aspect of the present invention, the sound emitting unit emits the audio signals, which are received from a plurality of opponent apparatuses, from sound source positions different from one another; and

the sound emitting unit emits an audio signal of the dial tone transmitted from the opponent apparatus from a new sound source position before emitting the audio signal received from any one of the plurality of opponent apparatuses from the new sound source position.

According to such a configuration, the sound source position is differently set for every opponent apparatus so as to carry out the sound source process for emitting an input voice signal. Therefore, it is possible to make the scene alive of the audio conference to be higher.

In this case, the proper filter factor of the adaptive filter is differently set for every sound source position. Here, the dial tone is emitted before the audio signal of the conference voice from a new sound source position is emitted. As a result, the filter factor of the adaptive filter can converge before the emission of the conference voice.

Further, an audio conference system of the invention includes a plurality of the audio conference apparatuses described above which are connected to one another.

Therefore, it is possible to suppress the effect caused by the recursion sound of the conference voice in the audio conference between plural apparatuses.

According to the audio conference apparatus and the audio conference system of the invention, since the filter factors of the adaptive filters converge by emitting the ring tone (dial tone of the opponent apparatus), the recursion sound of the conference voice is removed from the beginning of the conference. Therefore, the conference can smoothly proceed with a clear voice.

### BRIEF DESCRIPTION OF THE DRAWINGS

FIG. 1 is a functional block diagram illustrating an audio conference apparatus according to a first embodiment.

FIG. 2 is a flowchart illustrating a process flow of a communication control unit 12 shown in FIG. 1.

FIG. 3 is a flowchart illustrating a process flow of assigning a channel shown in FIG. 2.

FIG. 4 is a view illustrating an exemplary configuration of an audio conference system for connecting two audio conference apparatuses according to the first embodiment.

FIG. 5 is a view illustrating an exemplary configuration of an audio conference system for connecting three audio conference apparatuses according to the first embodiment.

FIG. 6 is a view illustrating an exemplary configuration of an audio conference system for connecting four audio conference apparatuses according to the first embodiment.

FIG. 7 is a functional block diagram illustrating an audio conference apparatus according to a second embodiment.

FIG. 8 is a view illustrating an example method of updating a channel table according to the second embodiment.

FIG. 9 is a functional block diagram illustrating an audio conference apparatus according to a third embodiment.

### DESCRIPTION OF REFERENCE NUMERALS AND SIGNS

1: Audio Conference Apparatus
10: Control Unit
11: Input-Output Connector
12: Communication Control Unit
13: Sound Emitting Direction Control Unit
14: D/A Converter
15: Outputting Audio Amp
16: Collecting Audio Amp
17: A/D Converter
18: Collecting Sound Beam Generating Unit
19: Collecting Sound Beam Selecting Unit
20: Echo Cancel Unit
21: Echo Cancel Circuit
22: Post Processor
23: Adaptive Filter
100: Audio Conference System
121: Identification Information Table
122: Ring Tone Generating Unit
123: Channel Table
124: Dial Tone Generating Unit
MIC: Microphone
SP: Speaker

### BEST MODE FOR CARRYING OUT THE INVENTION

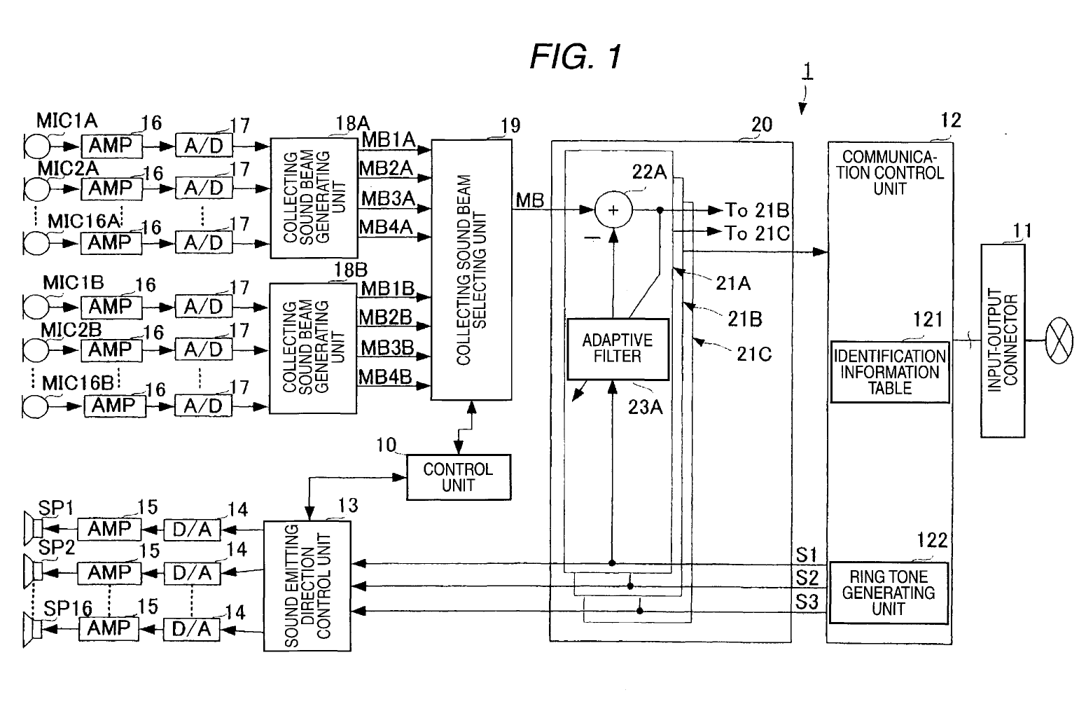

Hereinafter, an audio conference apparatus according to the first embodiment of the present invention will be described with reference to FIGS. 1 to 5. The audio conference apparatus of the present embodiment is to achieve the convergence of the filter factors by emitting the ring tone.

FIG. 1 is a view illustrating the configuration of the audio conference apparatus of the present embodiment. The audio conference apparatus 1 includes a control unit 10, an input-output connector 11, a communication control unit 12, a sound emitting direction control unit 13, D/A converters 14, outputting audio amps 15, a speaker array (speakers SP1 to SP16), a microphone array (microphones MIC1A to MIC16A and MIC1B to MIC16B), collecting audio amps 16, A/D converters 17, a collecting sound beam generating unit 18A, a collecting sound beam generating unit 18B, a collecting sound beam selecting unit 19, and an echo cancel unit 20.

The input-output connector 11 includes a LAN interface terminal, an analog audio input terminal, an analog audio output terminal, a digital audio input-output terminal, and the like, and all of which are not shown. The respective terminals can be used to connect with the opponent apparatuses. The input-output connector 11 outputs an input signal received from the opponent apparatus to the communication control unit 12, and receives an output signal, which is transmitted from one's own apparatus to the opponent apparatus, from the communication unit 12.

In the present embodiment, the input-output connector 11 is connected to the opponent apparatus on the LAN network through an LAN interface terminal, and inputs and outputs the input signals and the output signals as stream data. The stream data includes a header region and an audio recording region. In the header region, identification information which is unique for every audio conference apparatus is recorded. In the audio recording region, audio signals of the conference voice are recorded.

The communication control unit 12 reads the identification information from the header region of the stream data received by the input-output connector 11, and outputs the audio signals of the audio recording region of the stream data or the audio signals of the ring tone through different transmission paths (channels S1 to S3) for every identification information. Here, the total number of channels is ‘3’, that is, the maximum three opponent apparatuses can be connected. In addition, the total number of channels may be set in accordance with a specification. Further, the detailed operations of the communication control unit 12 will be described later.

The audio signals of each channel which are output from the communication control unit 12 are given to the sound emitting direction control unit 13 via the echo cancel unit 20.

The sound emitting direction control unit 13 carries out a virtual point sound source process. Specifically, the ring tone contained in the signal of each channel or the audio signal of the conference voice is emitted from a virtual point sound source which is set for every channel. For this reason, a delay process and an amplitude process are executed on the audio signals separately given to the speakers SP1 to SP16 of the speaker array. Here, since the total number of channels is ‘3’, the number of virtual point sound sources is also ‘3’. The channel S1 is set to the virtual point sound source at a rear right side of one's own apparatus, the channel S2 is set to the virtual point sound source at a rear center side of one's own apparatus, and the channel S3 is set to the virtual point sound source at a rear left side of one's own apparatus.

The audio signals separately emitted from the sound emitting direction control unit 13 are output to the D/A converters 14 respectively provided to the speakers SP1 to SP16. The respective D/A converters 14 convert separately-emitted audio signals into analog format signals to be output to the respective outputting audio amps 15. Further, the respective outputting audio amps 15 amplify the separately-emitted audio signals to be given to the speakers SP1 to SP16. Then, the speakers SP1 to SP16 convert the separately-emitted audio signals given from the outputting audio amps 15 into voice to be emitted to the outside.

Therefore, after the ring tone is emitted from each virtual point sound source, the conference voice of the opponent apparatus is emitted. Therefore, by emitting the ring tone, a notice of connection between one's own apparatus and the opponent apparatus can be given to participants in the audio conference using one's own apparatus, and the audio conference can smoothly proceed. In addition, by carrying out the emission from the virtual point sound source, it is possible to make the scene alive of the audio conference to be higher.

The microphones MIC1A to MIC16A and the microphones MIC1B to MIC16B each collects the voice emitted from the participant in the audio conference using the audio conference apparatus 1 or the recursion sound from the speaker, and each of which electrically converts the collected sound into a collected audio signal to be output to the collecting audio amp 16. Each collecting audio amp 16 amplifies the collected audio signal of the connected microphone to be given to the A/D converter 17. The A/D converter 17 digitally converts the collected audio signal received from the collecting audio amp 16 to be output to the collecting sound beam generating units 18A and 18B. The collecting sound beam generating units 18A and 18B carry out a predetermined delay process or the like on the collected audio signals of the respective microphones MIC1A to MIC16A and MIC1B to MIC16B and generate collecting sound beam signals MB1A to MB4A and collecting sound beam signals MB1B to MB4B. The collecting sound beam selecting unit 19 compares signal strengths between the collecting sound beam signals MB1A to MB4A and the collecting sound beam signals MB1B to MB4B, and selects a collecting sound beam signal suitable for a predetermined condition set in advance, and then outputs the resulting signal to the echo cancel unit 20 as a specific collecting sound beam signal MB.

Therefore, the specific collecting sound beam signal MB contains a speech voice of the participant in the audio conference who is seated in a collected region of the collecting sound beam selected and the recursion sound of the sound emitted from the speaker.

The echo cancel unit 20 is configured to connect three echo cancel circuits 21A to 21C in series corresponding to three independent channels (S1 to S3) of the audio signal transmission system. The output of the collecting sound beam selecting unit 19 is received in the echo cancel circuit 21A, and the output of the echo cancel circuit 21A is received in the echo cancel circuit 21B. Then, the output of the echo cancel circuit 21B is received in the echo cancel circuit 21C, and the output of the echo cancel circuit 21C is received in the communication control unit 12.

The echo cancel circuit 21A includes an adaptive filter 23A and a post processor 22A. The adaptive filter 23A of the echo cancel circuit 21A generates a pseudo-recursion sound signal when a signal of the channel S1 is output from the communication control unit 12. The post processor 22A outputs a first subtraction signal to the post processor 22B of the echo cancel circuit 21B, the first subtraction signal being obtained by subtracting the pseudo-recursion sound signal from the specific collecting sound beam signal MB output from the collecting sound beam selecting unit 19. The first subtraction signal gives feedback for the adaptive filter 23A to update the filter factor of the adaptive filter 23A. At this time, when the audio signal of the conference is newly transmitted through the channel S1 without transmitting the audio signal of the conference from the opponent apparatus, the filter factor converges on the basis of the ring tone emitted from the sound source position for the channel S1.

In addition, the echo cancel circuit 21B includes an adaptive filter 23B and a post processor 22B. The adaptive filter 23B of the echo cancel circuit 21B generates a pseudo-recursion sound signal when a signal of the channel S2 is output from the communication control unit 12. The post processor 22B outputs a second subtraction signal to the post processor 22C of the echo cancel circuit 21C, the second subtraction signal being obtained by subtracting the pseudo-recursion sound signal from the first subtraction signal output from the post processor 22A of the echo cancel circuit 21A. The second subtraction signal gives feedback for the adaptive filter 23B to update the filter factor of the adaptive filter 23B. At this time, when the audio signal of the conference is newly transmitted through the channel S2 without transmitting the audio signal of the conference from the opponent apparatus, the filter factor begins to converge on the basis of the ring tone emitted from the sound source position for the channel S2.

In addition, The echo cancel circuit 21C includes an adaptive filter 23C and a post processor 22C. The adaptive filter 23C of the echo cancel circuit 21C generates a pseudo-recursion sound signal when a signal of the channel S3 is output from the communication control unit 12. The post processor 22C outputs a third subtraction signal, as it is an output audio signal, to the communication control unit 12, the third subtraction signal being obtained by subtracting the pseudo-recursion sound signal from the second subtraction signal output from the post processor 22B of the echo cancel circuit 21B. The third subtraction signal gives feedback for the adaptive filter 23C to update the filter factor of the adaptive filter 23C. At this time, when the audio signal of the conference is newly transmitted through the channel S3 without transmitting the audio signal of the conference from the opponent apparatus, the filter factor begins to converge on the basis of the ring tone emitted from the sound source position for the channel S3.

The communication control unit 12 records the output audio signal received from the echo cancel circuit 21C on the audio recording region of the stream data, records the identification information of one's own apparatus on the header region, and the stream data is transmitted to the opponent apparatus through the network. In addition, when the opponent apparatus is connected, the stream data recorded with only the identification information is transmitted to the opponent apparatus through the network.

The audio conference apparatus of the present embodiment is configured as described above. Therefore, the filter factors of the respective adaptive filters 23A to 23C converge on the basis of the ring tone emitted from the sound emitting unit. By this, after the ring tone is emitted, the convergence of the adaptive filter proceeds, so that it is possible to remove the recursion sound. Accordingly, it is possible to reduce the effect of the recursion sound with respect to the conference voice immediately after receiving the ring tone.

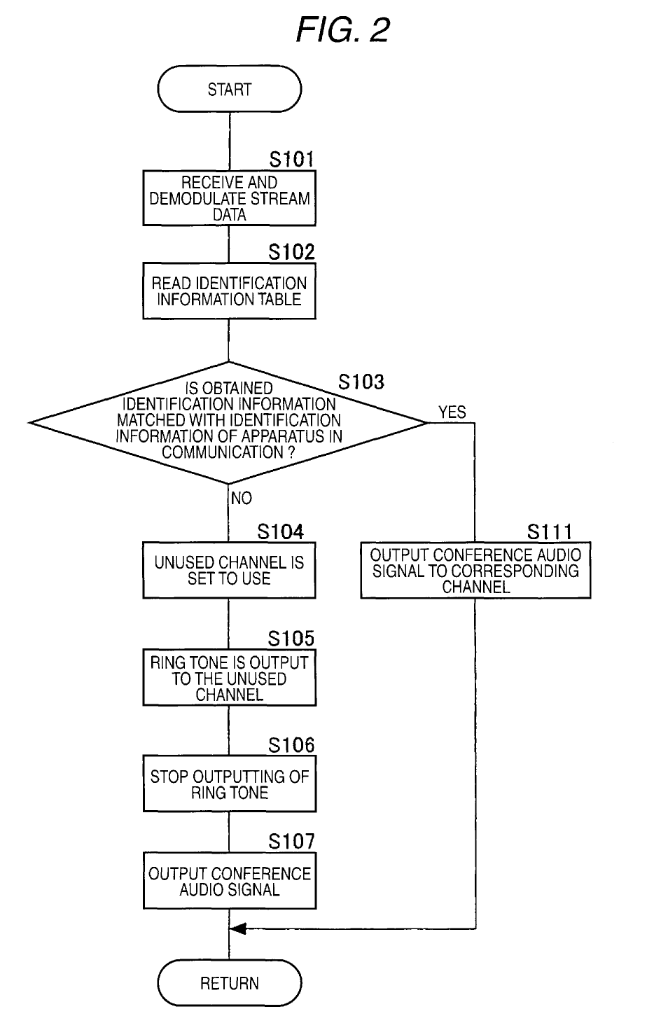

Next, the detailed operations of the communication control unit 12 will be described. FIG. 2 is a flowchart illustrating a process flow of the communication control unit 12. First, prior to demodulating the stream data which includes the audio signals received from the other audio conference apparatuses, the communication unit 12 receives and demodulates the stream data which does not include the audio signals received from the other audio conference apparatuses (S101). The communication control unit 12 obtains the identification information of a transmission source from the demodulated stream data, and reads an identification information table 121 (S102). In the identification information table 121, information for identifying the apparatus in communication already (apparatus-in-communication identification information) is recorded, and the communication control unit 12 compares the obtained identification information with the apparatus-in-communication identification information. When the communication control unit 12 detects that the obtained identification information is matched with the apparatus-in-communication identification information (S103: Y), the communication control unit 12 outputs the audio signal to the channel assigned already (S111).

On the other hand, when the communication control unit 12 detects that the obtained identification information is not matched with the apparatus-in-communication identification information (S103: N), the communication control unit 12 searches empty channels which are not used currently and assigns one channel among the empty channels (S104).

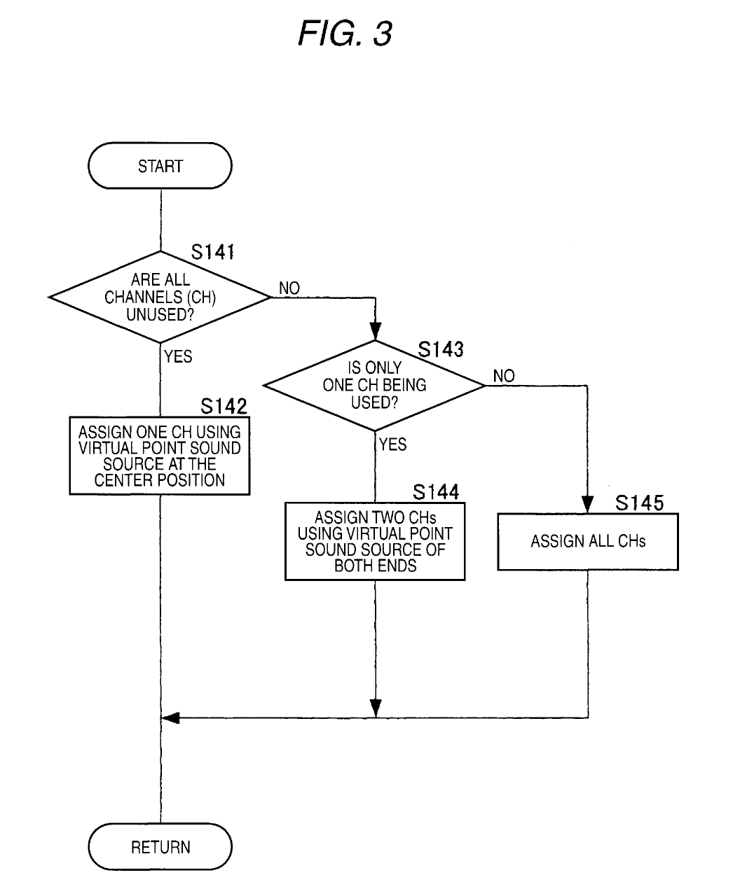

The assignment of the channel will be described in detail with reference to FIG. 3. FIG. 3 is a flowchart illustrating a process flow of the channel assignment. The communication control unit 12 searches the empty channels at a point of time when the new identification information is obtained. When all the channels are empty, the communication control unit 12 assigns a channel to set the virtual point sound source at the center position (S141→S142). When the communication control unit 12 detects that one channel has been assigned already, the communication control unit 12 assigns two channels, which set the virtual point sound sources at both ends, to the audio signal of the audio conference apparatus in communication already and the audio signal of the audio conference apparatus obtained with the new identification information (S141→S143→S144).

In addition, when the communication control unit 12 detects that two channels have been assigned already, the communication control unit 12 assigns the audio signal of the audio conference apparatus obtained with the new identification information to the channel to set the virtual point sound source at the center position. That is, the communication control unit 12 sets the audio signals of the two audio conference apparatuses in communication already and the audio signal of the audio conference apparatus obtained with the new identification information to the respective channels constituting all the channels (S143→S145). In addition, the assignment pattern of the channel is not limited to the above-mentioned pattern, and the virtual point sound sources may be assigned sequentially from the virtual point sound source of one end (for example, left end when it is viewed from the front surface in the sound emitting direction) to the virtual point sound source of the other end (right end when it is viewed from the front surface in a sound emitting direction).

Returning to FIG. 2, when the communication control unit 12 assigns the new channel to the audio signal for the new identification information (audio conference apparatus), the communication control unit 12 outputs the ring tone generated at a ring tone generating unit 122 from the assigned channel (S105).

The communication control unit 12 includes a timer, and when the ring tone is set to the output time of the ring tone set in advance, the output of the ring tone stops at the output time (S106). During that time, the ring tones emitted from the respective speakers SP of the speaker array are collected in the microphones MIC of the microphone array to be used at the time of optimizing the above-mentioned echo cancel unit 20. For this reason, the output time of the ring tone is set to a time enough for optimizing the echo cancel unit 20, and the time is previously set through experiment or the like.

In addition, the timer is not essential, and may be excluded in some cases. Further, in addition to outputting the ring tone in accordance with the output time of the ring tone set in advance, the output time may be set to a time until a user who hears the ring tone connects the line.

When the output of the ring tone stops, the communication control unit 12 demodulates the stream data including the audio signal received continuously. The communication control unit 12 outputs the demodulated audio signal to the channel through which the ring tone has been output (S107).

By carrying out such a process, the echo cancel unit 20 can be optimized at a point of time when the audio signal for the conference is emitted, and it is possible to efficiently carry out the echo cancel process on the new channel from the beginning of speech of the participant in the conference.

In addition, in the above description, the case where the new connected audio conference apparatus is one has been described. However, two audio conference apparatuses may be connected at the subsequently same time. In this case, a different ring tone is output for every audio conference apparatus, so that it is possible to carry out the optimization of the echo cancel unit 20 at the subsequently same time. At this time, as the respective ring tones, plural audio signals which are simply differentiated in frequency or plural audio signals which are different from each other at all may be used.

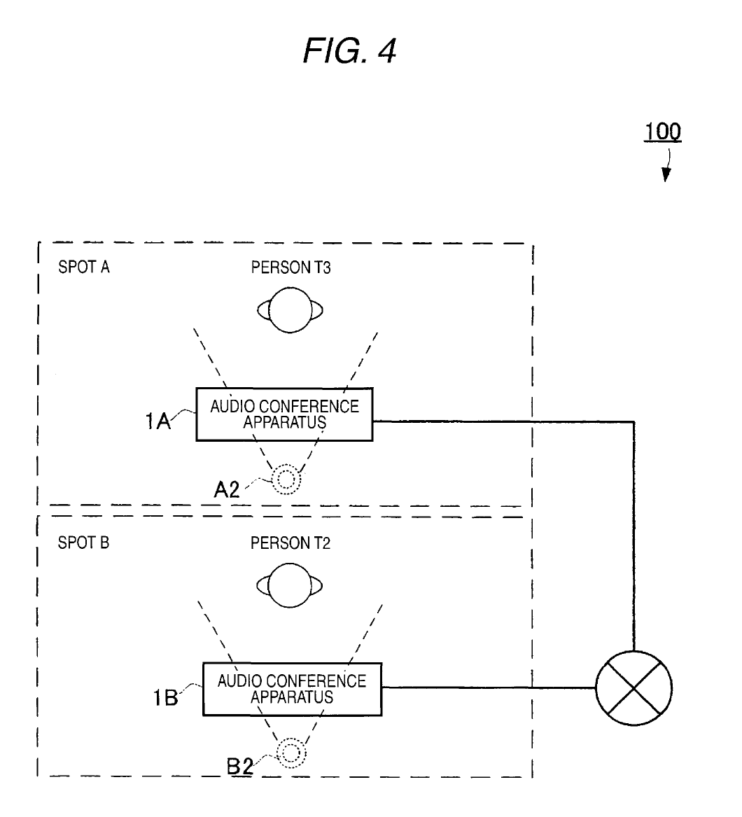

Next, examples of the connection configuration of the audio conference system using the audio conference apparatus according to the present embodiment will be described on the basis of FIGS. 4 to 6.

In the connection configuration shown in FIG. 4, the audio conference system 100 is configured such that the audio conference apparatus 1A provided on spot A is connected with the audio conference apparatus 1B provided on spot B through the LAN network. In addition, it is assumed that the filter factor immediately after connecting the audio conference apparatuses does not converge.

It this case, the audio conference apparatus 1A will be described as an example. The audio conference apparatus 1A receives the stream data from the opponent apparatus 1B. In the header region of the stream data, the identification information of the opponent apparatus 1B is recorded. However, in the audio recording region, there is no audio signal at the beginning of the connection. In addition, from one's own apparatus 1A records the opponent apparatus 1B with the same stream data, that is, the identification information in the header region of one's own apparatus 1A, and outputs the stream data which does not include the audio signal in the audio recording region.

The audio conference apparatus 1A carries out a searching for the identification information table 121 on the basis of the identification information of the stream data which has been received from the opponent apparatus 1B. Since the identification information table 121 is not recorded with the identification information of the opponent apparatus 1B at the point of time, the audio conference apparatus 1A newly registers the identification information of the opponent apparatus 1B in the identification information table 121. Then, the audio conference apparatus 1A assigns a suitable channel (S2) among the unused channels, outputs the audio signal of the ring tone, and the ring tone is emitted from the virtual point sound source A2 located at the rear center of one's own apparatus 1A.

Also in the opponent apparatus 1B, the ring tone is similarly emitted from the virtual point sound source B2.

As a result, the audio conference apparatuses 1A and 1B emit the ring tones, and the filter factors of the adaptive filters are updated to converge. Therefore, after emitting the ring tone, the optimization of the echo cancel unit 20 (convergence of the adaptive filter) proceeds in the respective audio conference apparatuses 1A and 1B, and the transmission and reception of the conference voice for the opponent apparatus (1B, 1A) can be carried out in a clear state by removing the recursion sound of the conference voice.

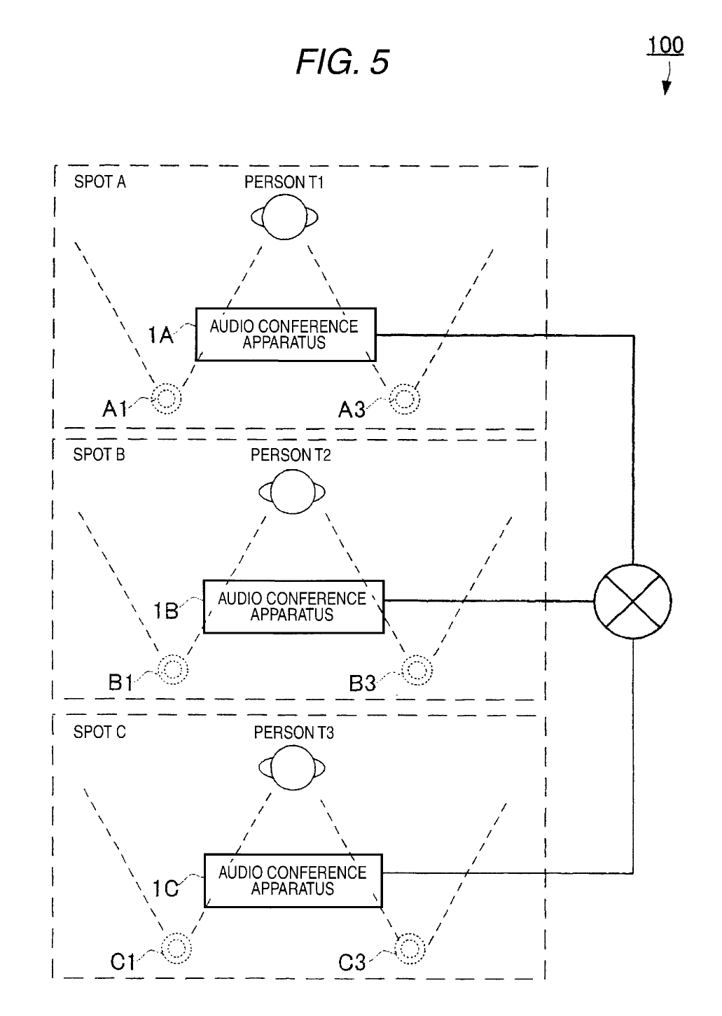

Next, in the above-mentioned connection configuration, an audio conference apparatus 1C is further connected as shown in FIG. 5. The audio conference apparatus 1A will be described as an example. The audio conference apparatus 1A receives the stream data from the opponent apparatus 1C. In addition, one's own apparatus 1A transmits the stream data to the opponent apparatus 1C.

The audio conference apparatus 1A carries out the searching for the identification information table 121 on the basis of the identification information of the stream data which has been received from the opponent apparatus 1C. Since the identification information table 121 is not recorded with the identification information of the opponent apparatus 1C at the point of time, the audio conference apparatus 1A newly registers the identification information of the opponent apparatus 1C in the identification information table 121. Then, the audio conference apparatus 1A discards the channel configuration of one channel set currently, outputs the audio signal of the ring tone from two new channels (S1 and S3), and the ring tone is emitted from the virtual point sound source A1 located at the rear right side of one's own apparatus 1A and the virtual point sound source A3 located at the rear left side of one's own apparatus 1A.

The opponent apparatus 1B emits the ring tone from the virtual point sound source B1 and the virtual point sound source B3. The opponent apparatus 1C emits the ring tone from the virtual point sound source C1 and the virtual point sound source C3.

As a result, the audio conference apparatuses 1A to 1C emit the ring tones, and the filter factors of the adaptive filters are updated to converge. Therefore, after emitting the ring tone, the optimization of the echo cancel unit proceeds in the respective audio conference apparatuses 1A to 1C, and the transmission and reception of the conference voice for the opponent apparatus can be carried out in a clear state by removing the recursion sound of the conference voice.

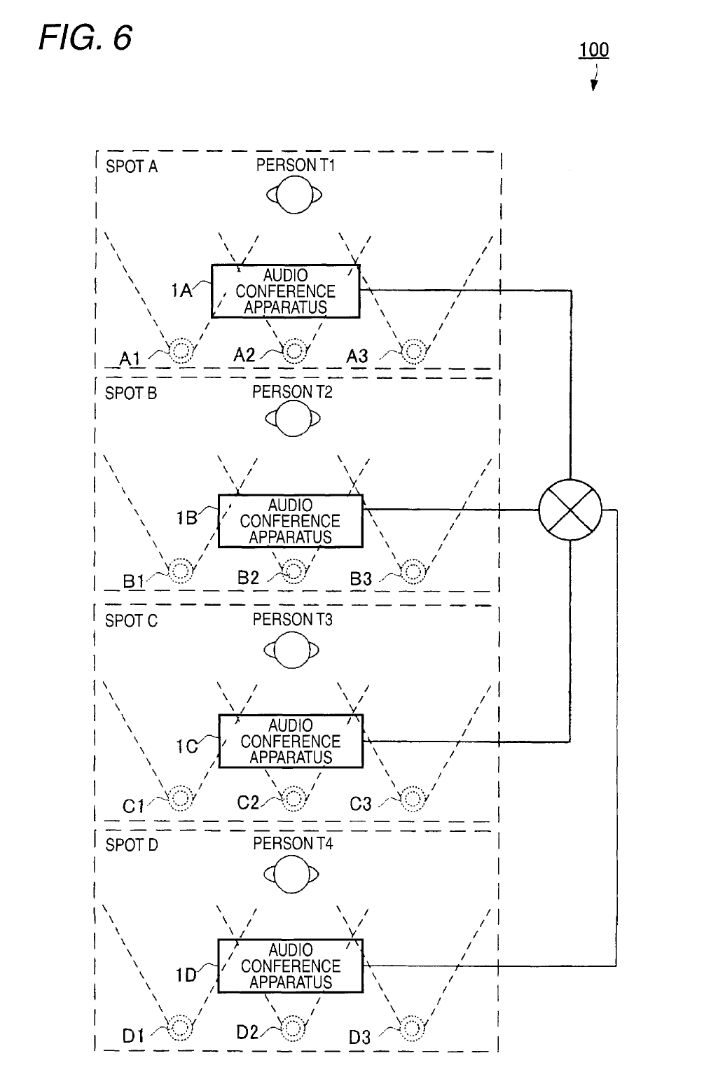

Next, in the above-mentioned connection configuration, an audio conference apparatus 1D is further connected as shown in FIG. 6. The audio conference apparatus 1A will be described as an example. The audio conference apparatus 1A receives the stream data from the opponent apparatus 1D. In addition, one's own apparatus 1A transmits the stream data to the opponent apparatus 1D.

The audio conference apparatus 1A carries out the searching for the identification information table 121 on the basis of the identification information of the stream data which has been received from the opponent apparatus 1D. Since the identification information table 121 is not recorded with the identification information of the opponent apparatus 1D at the point of time, the audio conference apparatus 1A newly registers the identification information of the opponent apparatus 1D in the identification information table 121. Then, the audio conference apparatus 1A discards the channel configuration of two channels (S1 and S3) set currently, outputs the audio signal of the ring tone from three new channels (S1, S2, and S3), and the ring tone is emitted from the virtual point sound source A2 located at the rear center of one's own apparatus 1A. In addition, at this time, instead of completely discarding the configuration of the channel, a process of adding a new channel to the channel configuration set currently may be applied.

The opponent apparatus 1B emits the ring tone from the virtual point sound source B2. The opponent apparatus 1C emits the ring tone from the virtual point sound source C2. The opponent apparatus 1D emits the ring tones from the virtual point sound sources D1 to D3, respectively. As a result, the audio conference apparatuses 1A to 1D emit the ring tone, and the filter factors of the adaptive filters are updated to converge. Therefore, after emitting the ring tone, the optimization of the echo cancel unit proceeds in the respective audio conference apparatuses 1A to 1D, and the transmission and reception of the conference voice for the opponent apparatus can be carried out in a clear state by removing the recursion sound of the conference voice.

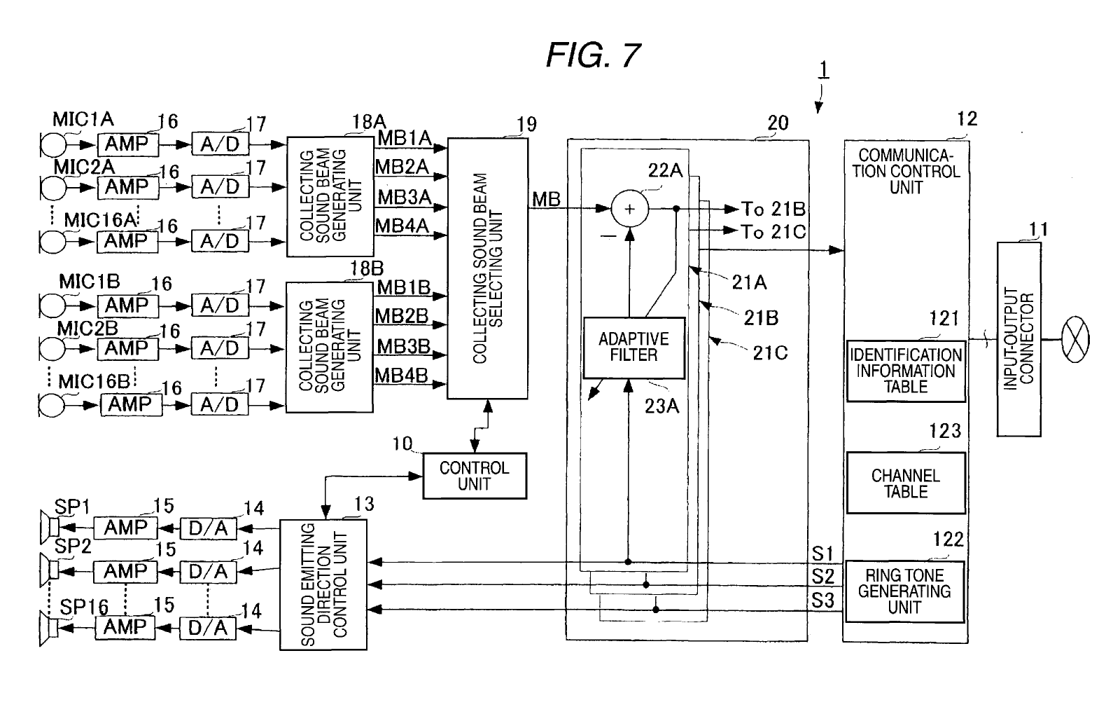

Next, the audio conference apparatus according to a second embodiment will be described. FIG. 7 is a view illustrating the configuration of the audio conference apparatus according to the present embodiment.

In the audio conference apparatus of the present embodiment, the channel table 123 is added to the communication control unit 12 of the audio conference apparatus of the first embodiment, and thus the channels and the virtual point sound sources are set in advance for every opponent apparatus.

The communication control unit 12 of the present embodiment is related to a method of selecting the audio signal to be output to each channel. In this method, a correlative relationship between each channel and the opponent apparatus is updated and stored in the channel table 123, and when a corresponding opponent apparatus is identified, the audio signal is output. At this time, in the beginning of communication, the detected new opponent apparatus is registered in the channel table 123, and after a second time, the searching for the opponent apparatus is carried out with respect to the channel table 123. Then, in the beginning of communication, the audio signal of the ring tone is output, and at the end of optimizing the echo cancel unit by the ring tone, the audio signal of the conference voice is output.

In the communication control unit 12, when the identification information detected from the header region of the stream data received from the opponent apparatus has been registered already in the identification information table 121 in which the previous detected identification information is registered, the audio signal in the audio recording region of the stream data is not changed and is output from the channel corresponding to the identification information. The corresponding channel is read from the channel table 123 in which combinations of the identification information and the channel are registered. In addition, the audio signal of the conference voice received from the echo cancel unit 20 is recorded in the audio recording region, and the stream data in which the identification information of one's own apparatus is recorded in the header region is transmitted to the opponent apparatus.

On the other hand, if the detected identification information is not yet recorded in the identification information table 121, the corresponding identification information is registered in the identification information table 121. In addition, the channel table 123 is updated, and the unused channels are assigned to the corresponding identification information. Then, the audio signal of the ring tone is generated in the ring tone generating unit 122, the audio signal of the ring tone is output from the channel which has not been used and is assigned with new identification information. In addition, the stream data in which the identification information of one's own apparatus is recorded in the header region is transmitted to the opponent apparatus.

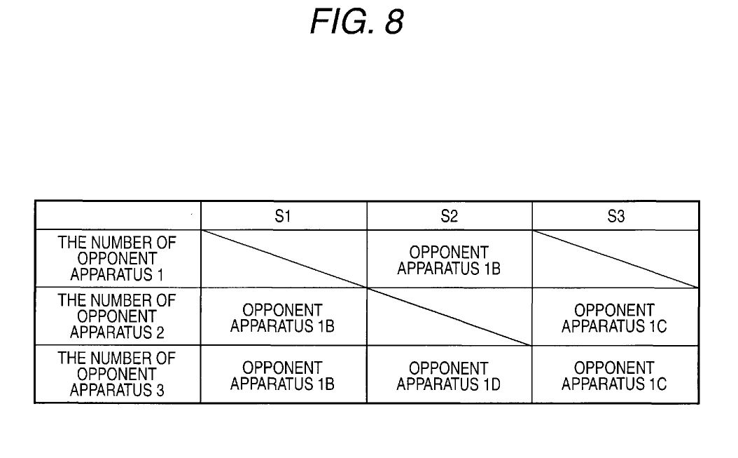

Here, an example of a method of updating the channel table 123 will be specifically described on the basis of FIG. 8. FIG. 8 is a view illustrating the example of the method of updating the channel table of the second embodiment. Here, one's own apparatus 1A is connected to the opponent apparatuses 1B, 1C, and 1D in this order. Further, in the virtual point sound source process at a subsequent stage, the respective channels are assigned in the opponent apparatuses 1B, 1C, and 1D such that the gap between the sound source positions adjacent to one another is widened at the maximum.

First, when the opponent apparatus 1B is initially connected, the identification information of the opponent apparatus 1B is newly assigned to the channel S2. Therefore, the ring tone is output from the channel S2 for a predetermined time, and thereafter the audio signal of the conference voice of the opponent apparatus 1B is output. Accordingly, the ring tone is emitted from the virtual point sound source in the front surface of one's own apparatus for a predetermined time, and thereafter the audio signal of the conference voice of the opponent apparatus 1B is emitted.

Next, when the opponent apparatus 1C is connected, the identification information of the opponent apparatus 1B is reassigned to the channel S1 from the channel S2, and the identification information of the opponent apparatus 1C is newly assigned to the channel S3. Therefore, the ring tone from the channel S1 and the channel S3 is output for a predetermined time, and thereafter the audio signals of the conference voices of the opponent apparatuses 1B and 1C are output. Accordingly, the ring tone is emitted from the virtual point sound source at the right side of one's own apparatus and the virtual point sound source at the left side of one's own apparatus for a predetermined time, and thereafter, the audio signal of the conference voice of the opponent apparatus 1B is emitted from the virtual point sound source at the right side of one's own apparatus, and the audio signal of the conference voice of the opponent apparatus 1C is emitted from the virtual point sound source at the left side of one's own apparatus.

Next, when the opponent apparatus 1D is connected, the identification information of the opponent apparatus 1D is newly assigned to the channel S2. Therefore, the ring tone is output from the channel S2 for a predetermined time, and thereafter the audio signal of the conference voice of the opponent apparatus 1D is output. Accordingly, the ring tone is emitted from the virtual point sound source at the front surface of one's own apparatus for a predetermined time, and thereafter, the audio signal of the conference voice of the opponent apparatus 1B is emitted from the virtual point sound source at the right side of one's own apparatus, the audio signal of the conference voice of the opponent apparatus 1C is emitted from the virtual point sound source at the left side of one's own apparatus, and the audio signal of the conference voice of the opponent apparatus 1D is emitted from the virtual point sound source at the front surface of one's own apparatus.

Also in a case where the audio conference system is configured by using the audio conference apparatus according to the present embodiments described above, the filter factors of the respective adaptive filters proceed to converge by emitting the ring tone in each audio conference apparatus. Therefore, the recursion sound of the conference voice is removed at the beginning of the conference, so that it is possible to carry out the conference with a clear voice.

Next, an example of the connection configuration of the audio conference system using the audio conference apparatus of the present embodiment will be described on the basis of FIGS. 4 to 6 described above.

In the connection configuration shown in FIG. 4, the audio conference system 100 is configured such that the audio conference apparatus 1A provided on spot A is connected with the audio conference apparatus 1B provided on spot B through the LAN network. In addition, it is assumed that the filter factor immediately after connecting the audio conference apparatuses does not converge.

It this case, the audio conference apparatus 1A will be described as an example. The audio conference apparatus 1A receives the stream data from the opponent apparatus 1B. In the header region of the stream data, the identification information of the opponent apparatus 1B is recorded. However, in the audio recording region, there is no audio signal at the beginning of the connection. In addition, from one's own apparatus 1A records the opponent apparatus 1B with the same stream data, that is, the identification information in the header region of one's own apparatus 1A, and outputs the stream data which does not include the audio signal in the audio recording region.

The audio conference apparatus 1A carries out the searching for the identification information table 121 on the basis of the identification information of the stream data which has been obtained from the opponent apparatus 1B. Since the identification information table 121 is not recorded with the identification information of the opponent apparatus 1B at the point of time, the audio conference apparatus 1A newly registers the identification information of the opponent apparatus 1B in the identification information table 121. Then, the audio conference apparatus 1A updates the channel table 123, outputs the audio signal of the ring tone from the channel (S2) through which the new identification information is assigned from an unused state, and the ring tone is emitted from the virtual point sound source A2 located at the rear center of one's own apparatus 1A.

Also in the opponent apparatus 1B, the ring tone is similarly emitted from the virtual point sound source B2.

As a result, the audio conference apparatuses 1A and 1B emit the ring tone, and the filter factors of the adaptive filters are updated to converge. Therefore, after emitting the ring tone, the optimization of the echo cancel unit (convergence of the adaptive filter) proceeds in the respective audio conference apparatuses 1A and 1B, and the transmission and reception of the conference voice for the opponent apparatus (1B, 1A) can be carried out in a clear state by removing the recursion sound of the conference voice.

Next, in the above-mentioned connection configuration, an audio conference apparatus 1C is further connected as shown in FIG. 5. The audio conference apparatus 1A will be described as an example. The audio conference apparatus 1A receives the stream data from the opponent apparatus 1C. In addition, one's own apparatus 1A transmits the stream data to the opponent apparatus 1C.

The audio conference apparatus 1A carries out the searching for the identification information table 121 on the basis of the identification information of the stream data which has been received from the opponent apparatus 1C. Since the identification information table 121 is not recorded with the identification information of the opponent apparatus 1C at the point of time, the audio conference apparatus 1A newly registers the identification information of the opponent apparatus 1C in the identification information table 121. Then, the audio conference apparatus 1A updates the channel table 123, outputs the audio signal from the channels (S1, S3) through which the new identification information is assigned from the unused states, and the ring tone is emitted from the virtual point sound source A1 located at the rear right side of one's own apparatus 1A and the virtual point sound source A3 located at the rear left side of one's own apparatus 1A.

The opponent apparatus 1B emits the ring tone from the virtual point sound source B1 and the virtual point sound source B3. The opponent apparatus 1C emits the ring tone from the virtual point sound source C1 and the virtual point sound source C3.

As a result, the audio conference apparatuses 1A to 1C emit the ring tone, and the filter factors of the adaptive filters are updated to converge. Therefore, after emitting the ring tone, the optimization of the echo cancel unit proceeds in the respective audio conference apparatuses 1A to 1C, and the transmission and reception of the conference voice for the opponent apparatus can be carried out in a clear state by removing the recursion sound of the conference voice.

Next, in the above-mentioned connection configuration, an audio conference apparatus 1D is further connected as shown in FIG. 6. The audio conference apparatus 1A will be described as an example. The audio conference apparatus 1A receives the stream data from the opponent apparatus 1D. In addition, one's own apparatus 1A transmits the stream data to the opponent apparatus 1D.

The audio conference apparatus 1A carries out the searching for the identification information table 121 on the basis of the identification information of the stream data which has been received from the opponent apparatus 1D. Since the identification information table 121 is not recorded with the identification information of the opponent apparatus 1D at the point of time, the audio conference apparatus 1A newly registers the identification information of the opponent apparatus 1D in the identification information table 121. Then, the audio conference apparatus 1A updates the channel table 123, outputs the audio signal from the channel (S2) through which the new identification information is assigned from the unused states, and the ring tone is emitted from the virtual point sound source A2 located at the rear center of one's own apparatus 1A.

The opponent apparatus 1B emits the ring tone from the virtual point sound source B2. The opponent apparatus 1C emits the ring tone from the virtual point sound source C2. The opponent apparatus 1D emits the ring tones from the virtual point sound sources D1 to D3.

As a result, the audio conference apparatuses 1A to 1D emit the ring tone, and the filter factors of the adaptive filters are updated to converge. Therefore, after emitting the ring tone, the optimization of the echo cancel unit proceeds in the respective audio conference apparatuses 1A to 1D, and the transmission and reception of the conference voice for the opponent apparatus can be carried out in a clear state by removing the recursion sound of the conference voice.

Further, in the embodiments described above, when it is detected that the opponent apparatus is newly connected, the ring tone is output to the circuit at the subsequent stage of the communication control unit. However, the present invention may be configured to transmit the dial tone to the opponent apparatus instead of the ring tone.

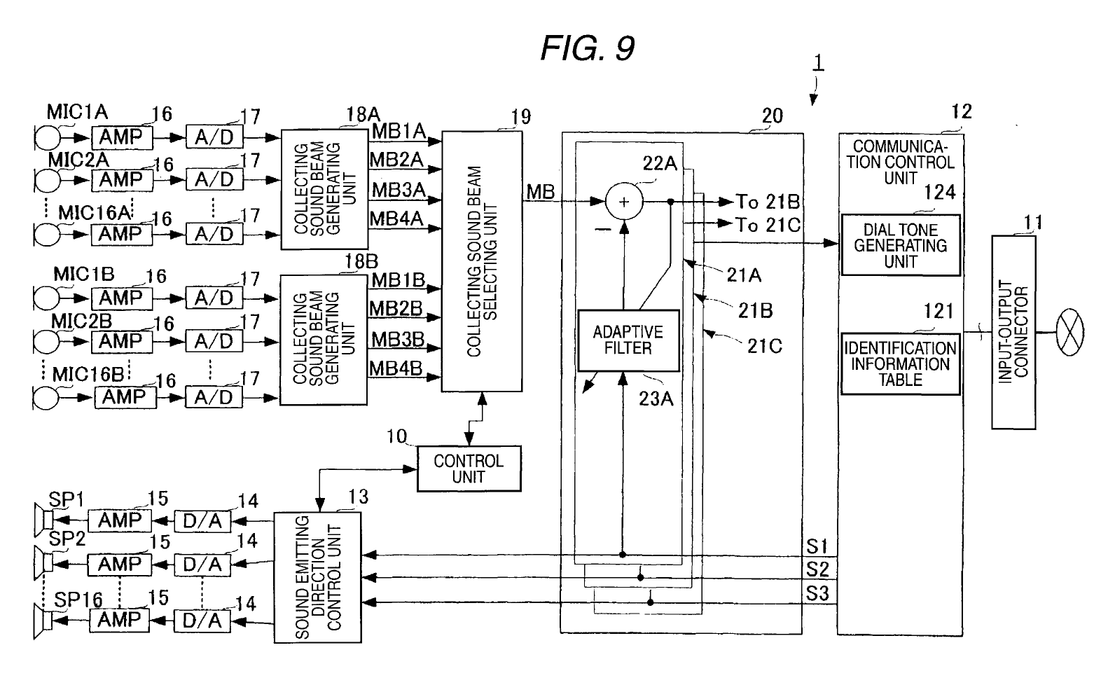

Next, the audio conference apparatus according to a third embodiment of the present invention will be described on the basis of FIG. 9. FIG. 9 is a functional block diagram illustrating the audio conference apparatus according to the third embodiment. The audio conference apparatus of the present embodiment transmits the dial tone to the opponent apparatus, and thus the convergence of the filter factors of the two is achieved by emitting the dial tone to each other. Further, in the following description, the third embodiment is described by using the processes on the basis of the first embodiment. However, the third embodiment is also applicable to the processes on the basis of the second embodiment.

The audio apparatus 1 of the present embodiment is different from the first embodiment in that the communication control unit 12 includes the dial tone generating unit 124 instead of the ring tone generating unit 122.

Hereinafter, the detailed operations of the communication control unit 12 will be described. The communication control unit 12 determines whether or not the audio signal received from the echo cancel unit 20, that is, the audio signal of the conference voice, is recorded in the audio recording region of the stream data to be transmitted to the opponent apparatus, or whether or not the audio signal of the dial tone is recorded on the basis of whether or not the stream data has been newly received.

In the audio conference apparatus 1 of the present embodiment, the communication control unit 12 is configured such that, when the identification information detected from the header region of the stream data received from the opponent apparatus has been already registered in the identification information table 121, the audio signal of the audio recording region of the stream data is not changed to be output from the channel corresponding to the identification information. In addition, the audio signal of the conference voice received from the echo cancel unit 20 is recorded in the audio recording region, and the stream data in which the identification information of one's own apparatus is recorded in the header region is transmitted to the opponent apparatus.

On the other hand, when the detected identification information has not been recorded in the identification information table 121, the communication control unit 12 makes the dial tone generating unit 124 generate the audio signal of the dial tone, records the audio signal of the dial tone in the audio recording region, and transmits the stream data, in which the identification information of one's own apparatus is recorded in the header region, to the opponent apparatus. In addition, the communication control unit 12 registers the identification information, which is recorded in the header region of the stream data received from the opponent apparatus, to the identification information table 121. Then, the audio signal of the dial tone is output from the channels which has not been used and is assigned with new identification information. It is possible to optimize the echo cancel unit 20 by carrying out the same process on the dial tone as that of the ring tone of the above-mentioned embodiment.

As shown in the embodiments described above, according to the present invention, since the echo cancel unit is optimized in advance before the conference voice is transmitted or received, the audio conference can smoothly proceed by removing the recursion sound of the conference voice.

Even though the present invention is described with reference to the specific embodiments in detail, it will be apparent to those skilled in the art from this disclosure that various changes or modifications can be made herein without departing from the spirit, the scope, or the intension of the present invention.

The present application is based on Japanese Patent Application No. filed on Dec. 19, 2006, and the contents of which are incorporated herein for reference.

1. An audio conference apparatus, comprising:
a communication control unit which transmits and receives an audio signal to and from an opponent apparatus connected;
a sound emitting unit which emits the audio signal received in the communication control unit;
a sound collecting unit which collects an audio signal around one's own apparatus including a recursion sound of the audio signal emitted from the sound emitting unit; and
an echo cancel unit which generates a pseudo-recursion sound signal on the basis of the audio signal received in the communication control unit and outputs an audio signal obtained by subtracting the pseudo-recursion sound signal from the audio signal collected at the sound collecting unit to the communication control unit,
wherein the sound emitting unit emits an audio signal made of a ring tone before emitting the audio signal received in the communication control unit.

2. The audio conference apparatus according to claim 1, wherein the sound emitting unit emits the audio signals, which are received in the communication control unit from a plurality of opponent apparatuses, from sound source positions different from one another; and
wherein the sound emitting unit emits an audio signal of a ring tone with respect to a new sound source position before emitting the audio signal received from any one of the plurality of opponent apparatuses from the new sound source position.

3. An audio conference apparatus, comprising:
a communication control unit which transmits and receives an audio signal to and from an opponent apparatus connected;
a sound emitting unit which emits the audio signal received in the communication control unit;
a sound collecting unit which collects an audio signal around one's own apparatus including a recursion sound of the audio signal emitted from the sound emitting unit; and
an echo cancel unit which generates a pseudo-recursion sound signal on the basis of the audio signal received in the communication control unit and outputs an audio signal obtained by subtracting the pseudo-recursion sound signal from the audio signal collected at the sound collecting unit to the communication control unit,
wherein the communication control unit transmits an audio signal of a dial tone to the opponent apparatus before transmitting the audio signal received from the echo cancel unit to the opponent apparatus; and
wherein the echo cancel unit optimizes the pseudo-recursion signal in advance by using the audio signal of the dial tone transmitted from the opponent apparatus.

4. The audio conference apparatus according to claim 3,
wherein the sound emitting unit emits the audio signals, which are received from a plurality of opponent apparatuses, from sound source positions different from one another; and
wherein the sound emitting unit emits an audio signal of the dial tone transmitted from the opponent apparatus from a new sound source position before emitting the audio signal received from any one of the plurality of opponent apparatuses from the new sound source position.

5. An audio conference system comprising a plurality of the audio conference apparatus according to claim 1, which are connected to one another.

6. An audio conference system comprising a plurality of the audio conference apparatus according to claim 3, which are connected to one another.
